(19) United States
(12) Patent Application Publication
(10) Pub. No.: US 2019/0090671 A1
(43) Pub. Date: Mar. 28, 2019

(54) CUP HOLDER ASSEMBLY FOR COOLER

(71) Applicant: Esther Torres-Umi, Hoolehua, HI (US)

(72) Inventor: Esther Torres-Umi, Hoolehua, HI (US)

(21) Appl. No.: 15/715,373

(22) Filed: Sep. 26, 2017

(51) Int. Cl. A47G 23/02; B67D 1/08; B67D 1/16

(52) U.S. Cl. CPC A47G 23/0225; B67D 1/0004; B67D 1/16; B67D 1/0894

(57) ABSTRACT

A cup holder assembly for a cooler that includes: a vertical support; a lip extending horizontally from a top edge of the vertical support; a cup receiver attached to the vertical support; and a tray catch attached to a bottom edge for the vertical support. The cup receiver is preferably cylindrical and the vertical support is adapted for placement under a cooler.

### BACKGROUND OF THE INVENTION

### Field of Invention

The present invention relates to a cup holder that works in conjunction with a conventional beverage cooler.

### Description of Related Art

Beverage coolers are used in various sizes and forms to hold beverages for dispensing purposes. Some beverage coolers are drum shaped with a loading capacity up to 5 to 8 gallons. A spicket or spout is provided and the cooler is set on a flat surface allowing for a user to manipulate the spout or spicket to allow the release of fluid in the cooler. This dispensing process essentially takes most users two hands one to hold the cup under the spout and the other to depress or lift the spout to allow the flow of fluid into their cup. Although effective, it could be cumbersome for a user if they are also handling a plate, for instance, or other food therefore the user would be required to place the plate on a flat surface while retrieving a beverage from the cooler. Another problem with these such coolers is that a drip occasionally continues after the spout is released. As such there have been certain devices developed to address the drip in the form of drip catches as disclosed in the U.S. Patent Publication No. 2015/0053277, which discloses a drip catcher that slides under the cooler and is positioned under the spout to enable the catching of residue liquids. Another example of a drip catcher is shown in U.S. Patent Publication 2010/0065583 that discloses a drip catcher that hooks onto the spout of the cooler and is positioned directly under the spout.

These catchers, although effective to catch miscellaneous fluids do not address any support mechanism for the cup. The present invention is directed to provide support for a cup along with a catcher that's easily placed under a spout of a cooler.

### SUMMARY OF THE INVENTION

The present invention relates to a cup holder assembly for a cooler that includes: a vertical support; a lip extending horizontally from a top edge of the vertical support; a cup receiver attached to the vertical support; and a tray catch attached to a bottom edge for the vertical support. The cup receiver is preferably cylindrical and the vertical support is adapted for placement under a cooler.

### BRIEF DESCRIPTION OF DRAWINGS

FIG. 1 depicts a cup holder assembly under a cooler in accordance with the present invention.

FIG. 2 depicts a perspective view of the cup holder assembly receiving a cup.

### DETAILED DESCRIPTION

The present invention relates to a cup holder assembly that has a vertical support with a lip that extends horizontally from the top edge of the vertical support. This lip is placed under a cooler, which provides sufficient weight to stabilize the cup holder assembly under a spout of the cooler. Another feature of the cup holder assembly includes a cup receiver attached to the vertical support and a tray catch attached to the bottom edge of the vertical support. The cup receiver supports that cup during the filling process.

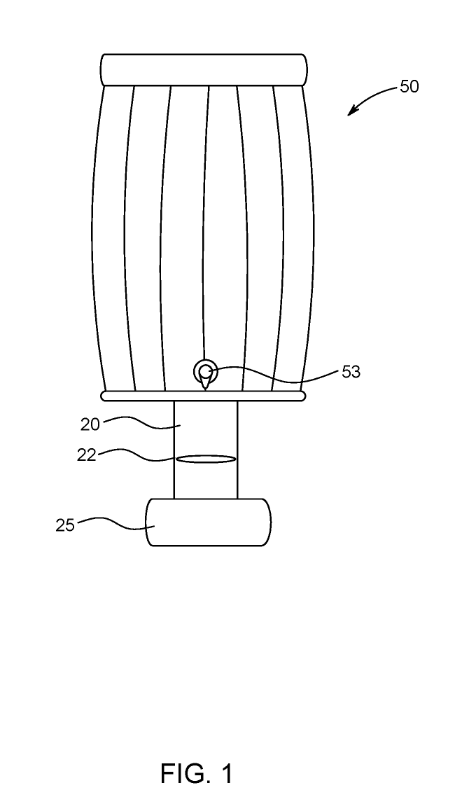

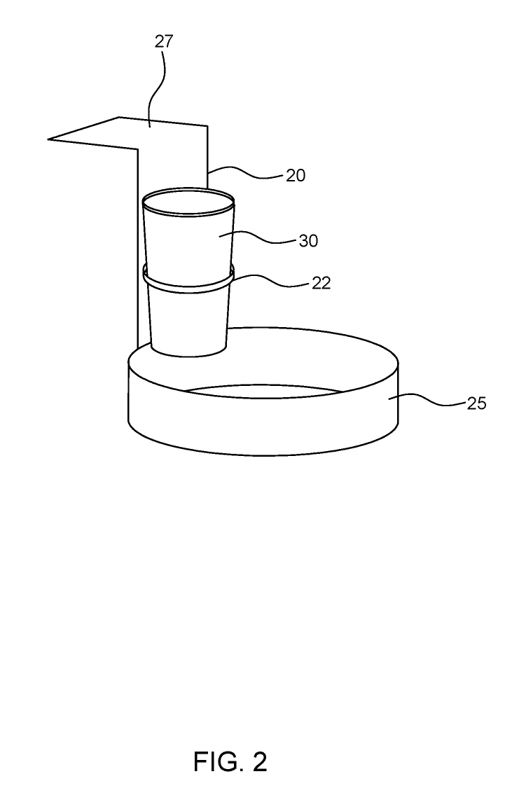

In reference to FIG. 1, a cooler 50 is shown with a cup holder assembly 20 in accordance with the present invention. Cup holder assembly 20 includes a vertical support 23 that supports a cup receiver 22 and a tray catch 25 at the bottom edge of the vertical support. The cup receiver 22 is preferably symmetrical in shape and allows for the placement of a cup within the opening of the cup receiver 22. The cup receiver 22 is roughly positioned at a center position along the vertical support 23. A spout 53 is provided for the cooler 50, where the cup holder assembly 20 is placed directly under the spout 53 to receive fluids from the cooler 50. A cup 30 may be placed into the cup receiver as shown in FIG. 2. FIG. 2 provides a perspective view of the cup holder assembly 20 and gives a view of the tray catch 25. The tray catch 25 is shown as circular but is not limited to this particular shape and may be designed in any suitable shape to catch the fluids that may accidentally drip from the spout at the removal of the cup 30. Use of the present invention allows the user to dispense fluids from the cooler with one hand while a cup is secured within the cup receiver 22. It also provides an additional feature of the tray catch 25.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A cup holder assembly for a cooler comprising:
a vertical support;
a lip extending horizontally from a top edge of the vertical support;
a cup receiver attached to the vertical support; and
a tray catch attached to a bottom edge for the vertical support.

2. The cup holder assembly according to claim 1, where the cup receiver is cylindrical.

3. The cup holder assembly according to claim 1, the vertical support is adapted for placement under a cooler.
